(19) United States
(12) Patent Application Publication
(10) Pub. No.: US 2025/0217972 A1
(43) Pub. Date: Jul. 3, 2025

(54) KEYPOINT DETECTION METHOD FOR MEDICAL IMAGING, AND MEDICAL IMAGING METHOD, AND SYSTEM

(71) Applicant: GE Precision Healthcare LLC, Waukesha, WI (US)

(72) Inventors: Ting Ye, Beijing (CN); Xiaolan Liu, Beijing (CN); Yuyang Huang, Beijing (CN); Qingyu Dai, Beijing (CN); Hao Yang, Beijing (CN); Qiang Xu, Beijing (CN); Fan Li, Beijing (CN)

(21) Appl. No.: 18/984,914

(22) Filed: Dec. 17, 2024

(30) Foreign Application Priority Data
Jan. 2, 2024 (CN) 202410001634.2

(51) Int. Cl. G06T 7/00; G06T 7/11; G06T 7/174; G06T 7/73; G06V 10/24; G06V 10/26; G06V 10/32; G06V 10/44

(52) U.S. Cl. CPC G06T 7/0012; G06T 7/11; G06T 7/174; G06T 7/74; G06V 10/24; G06V 10/273; G06V 10/32; G06V 10/44; G06T 2207/10016; G06T 2207/10024; G06T 2207/10028; G06T 2207/10088; G06T 2207/20221; G06T 2207/30004; G06T 2207/30196; G06V 2201/03

(57) ABSTRACT

A keypoint detection method for medical imaging, a medical imaging method and a medical imaging system is presented. The keypoint detection method for medical imaging includes: acquiring a color image and a depth image of a subject, the color image being synchronized with the depth image in a temporal dimension; performing image fusion on the color image and the depth image, to generate a fused image; and performing keypoint detection on the fused image, to generate keypoint distribution information of the subject.

### CROSS REFERENCE TO RELATED APPLICATIONS

The present application claims priority and benefit of Chinese Patent Application No. 202410001634.2 filed on Jan. 2, 2024, which is incorporated herein by reference in its entirety.

### TECHNICAL FIELD

Embodiments of the present application relate to the technical field of medical devices, and in particular to a keypoint detection method for medical imaging, a medical imaging method, and a medical imaging system.

### BACKGROUND

In a medical scenario, landmark points (also known as keypoints) may refer to coordinate points having anatomical significance, usually junction points between different tissues and organs, or recognition points that have the most distinctive morphological features in a subject being studied. In medicine, these keypoints may be used for tissue structure recognition. For example, in a medical imaging scenario, tissues or organs corresponding to the keypoints may be recognized by keypoint distribution information of a scan subject, thereby enabling determination of a region to be scanned in the scan subject.

### SUMMARY

The inventors have found that the existing means of determining keypoint distribution information of a subject have certain limitations. At present, keypoint detection is usually performed separately for a color image and a depth image of a subject, and keypoint distribution information is determined according to the detection result of the color image and the detection result of the depth image.

In the above method, it is necessary to separately train corresponding deep learning models for color images and depth images, resulting in detection operations being complex, requiring a relatively long time and having low detection efficiency; in addition, the color image or the depth image is separately subjected to keypoint detection, which occupies more computing resources and cannot ensure the accuracy of the detection result.

In view of at least one of the above problems, provided in the embodiments of the present application are a keypoint detection method for medical imaging, a medical imaging method, and a medical imaging system.

Provided in embodiments of the present application are a keypoint detection method for medical imaging, a medical imaging method, and a medical imaging system.

According to one aspect of the embodiments of the present application, provided is a keypoint detection method for medical imaging. The method comprises: acquiring a color image and a depth image of a subject, the color image being synchronized with the depth image in a temporal dimension; performing image fusion on the color image and the depth image, to generate a fused image; and performing keypoint detection on the fused image, to generate keypoint distribution information of the subject.

According to one aspect of the embodiments of the present application, a medical imaging method is provided. The method comprises: determining keypoint distribution information according to the keypoint detection method for medical imaging described above; and performing a scanning operation according to the determined keypoint distribution information.

According to one aspect of the embodiments of the present application, a medical imaging system is provided. The system includes: a controller, configured to perform the keypoint detection method for medical imaging described above; and a scanning assembly, performing a scanning operation according to keypoint distribution information determined by the controller.

One of the beneficial effects of the embodiments of the present application is that: by means of acquiring a color image and a depth image which are synchronized in the temporal dimension, performing image fusion on the color image and the depth image to generate a fused image, and performing keypoint detection on the fused image, to generate the keypoint distribution information, the accuracy and reliability of the keypoint distribution information can be improved, required computing resources can be reduced, computational efficiency can be improved, a detection operation can be simplified, and detection efficiency can be ensured.

With reference to the following description and drawings, specific implementations of the embodiments of the present application are disclosed in detail, and the means by which the principles of the embodiments of the present application can be employed are illustrated. It should be understood that the embodiments of the present application are not limited in scope thereby. Within the scope of the spirit and clauses of the appended claims, the embodiments of the present application include many changes, modifications, and equivalents.

### BRIEF DESCRIPTION OF THE DRAWINGS

The included drawings are used to provide further understanding of the embodiments of the present application, which constitute a part of the description and are used to illustrate the implementations of the present application and explain the principles of the present application together with textual description. Evidently, the drawings in the following description are merely some embodiments of the present application, and a person of ordinary skill in the art may obtain other implementations according to the drawings without involving inventive effort. In the drawings:

FIG. 1 is a schematic diagram of a magnetic resonance imaging system according to an embodiment of the present application;

FIG. 2 is a schematic diagram of a keypoint detection method for medical imaging according to an embodiment of the present application;

FIG. 3 is a schematic diagram of the implementation of step 201 according to an embodiment of the present application;

FIG. 4 is a schematic diagram of the implementation of step 202 according to an embodiment of the present application;

FIG. 5 is a schematic diagram of the implementation of step 203 according to an embodiment of the present application;

FIG. 6 is another schematic diagram of the implementation of step 202 according to an embodiment of the present application;

FIG. 7 is a schematic diagram of image fusion according to an embodiment of the present application;

FIG. 8 is another schematic diagram of the implementation of step 202 according to an embodiment of the present application;

FIG. 9 is another schematic diagram of image fusion according to an embodiment of the present application;

FIG. 10 is a schematic diagram of a flow of steps 202 and 204 according to an embodiment of the present application;

FIG. 11 is a schematic diagram of a flow of generating an input image according to an embodiment of the present application;

FIG. 12 is a keypoint detection apparatus for medical imaging according to an embodiment of the present application; and

FIG. 13 is a schematic diagram of a medical imaging method according to an embodiment of the present application.

### DETAILED DESCRIPTION

The foregoing and other features of the embodiments of the present application will become apparent from the following description with reference to the drawings. In the description and drawings, specific implementations of the present application are disclosed in detail, and part of the implementations in which the principles of the embodiments of the present application may be employed are indicated. It should be understood that the present application is not limited to the described implementations. On the contrary, the embodiments of the present application include all modifications, variations, and equivalents which fall within the scope of the appended claims.

In the embodiments of the present application, the terms “first” and “second” etc., are used to distinguish different elements, but do not represent a spatial arrangement or temporal order, etc., of these elements, and these elements should not be limited by these terms. The term “and/or” includes any and all combinations of one or more associated listed terms. The terms “comprise”, “include”, “have”, etc., refer to the presence of described features, elements, components, or assemblies, but do not exclude the presence or addition of one or more other features, elements, components, or assemblies.

In the embodiments of the present application, the singular forms “a” and “the”, etc., include plural forms, and should be broadly construed as “a type of” or “a class of” rather than being limited to the meaning of “one”. Furthermore, the term “the” should be construed as including both the singular and plural forms, unless otherwise specified in the context. In addition, the term “according to” should be construed as “at least in part according to . . . ” and the term “on the basis of” should be construed as “at least in part on the basis of . . . ”, unless otherwise specified in the context.

In the embodiments of the present application, the term “landmark” may be equivalently replaced with “keypoint”, “key coordinate point”, or “landmark point”. The term “scan subject” may be equivalently replaced with “subject”, “subject to be scanned”, “patient”, or “subject being studied”, which may be a human being or an animal, or the like.

In the embodiments of the present application, the term “include/comprise” when used herein refers to the presence of features, integrated components, steps, or assemblies, but does not preclude the presence or addition of one or more other features, integrated components, steps, or assemblies.

The features described and/or illustrated for one implementation may be used in one or more other implementations in the same or similar manner, be combined with features in other embodiments, or replace features in other implementations.

In the embodiments of the present application, obtained landmark information (e.g., keypoint distribution information) is applicable to a variety of medical imaging scenarios, including, but not limited to, magnetic resonance imaging (MRI), computed tomography (CT), ultrasound imaging, X-ray imaging, positron emission computed tomography (PET), single photon emission computed tomography (SPECT), PET/CT, PET/MR, or any other suitable medical imaging scenario.

In the embodiments of the present application, the method, apparatus, and system of the present application are exemplarily described by taking an MRI scenario as an example. It should be understood that the contents of the embodiments of the present application are also applicable to other medical imaging scenarios.

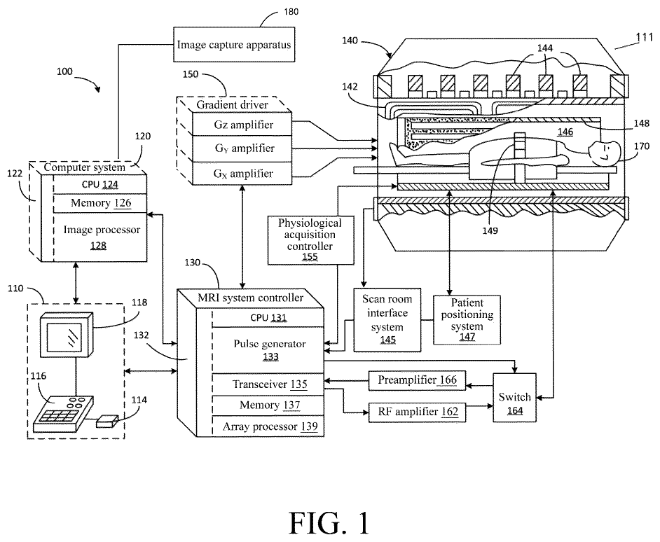

FIG. 1 is a schematic diagram of a magnetic resonance imaging (MRI) system 100 according to an embodiment of the present application.

As shown in FIG. 1, the MRI system 100 includes a scanning unit 111. The scanning unit 111 is used to perform a magnetic resonance scan of a subject (e.g., a human body) 170 to generate image data of a region of interest of the subject 170, wherein the region of interest may be a pre-determined anatomical site or anatomical tissue.

The operation of the MRI system 100 is controlled by an operator workstation 110 that includes an input device 114, a control panel 116, and a display 118. The input device 114 may be a joystick, a keyboard, a mouse, a trackball, a touch-activated screen, voice control, or any similar or equivalent input device. The control panel 116 may include a keyboard, a touch-activated screen, voice control, a button, a slider, or any similar or equivalent control device. The operator workstation 110 is coupled to and in communication with a computer system 120 that enables an operator to control the generation and display of images on the display 118. The computer system 120 includes various components that communicate with one another via an electrical and/or data connection module 122. The connection module 122 may employ a direct wired connection, a fiber optic connection, a wireless communication link, etc. The computer system 120 may include a central processing unit (CPU) 124, a memory 126, and an image processor 128. In some embodiments, the image processor 128 may be replaced by medical imaging functions implemented in the CPU 124. The computer system 120 may be connected to an archive media device, a persistent or backup memory, or a network. The computer system 120 may be coupled to and communicates with a separate MRI system controller 130.

The MRI system controller 130 includes a set of components that communicate with one another via an electrical and/or data connection module 132. The connection module 132 may employ a direct wired connection, a fiber optic connection, a wireless communication link, etc. The MRI system controller 130 may include a CPU 131, a sequence pulse generator (also known as a pulse generator) 133 in communication with the operator workstation 110, a transceiver (also known as an RF transceiver) 135, a memory 137, and an array processor 139.

In some embodiments, the sequence pulse generator 133 may be integrated into a resonance assembly 140 of the scanning unit 111 of the MRI system 100. The MRI system controller 130 may receive a command from the operator workstation 110, and is coupled to the scanning unit 111 to indicate an MRI scanning sequence to be performed during an MRI scan, so as to be used to control the scanning unit 111 to perform the flow of the aforementioned magnetic resonance scan. The MRI system controller 130 is further coupled to a gradient driver system (also known as gradient driver) 150 and is in communication therewith, and the gradient driver system is coupled to a gradient coil assembly 142 to generate a magnetic field gradient during an MRI scan.

The sequence pulse generator 133 may further receive data from a physiological acquisition controller 155 that receives signals from a plurality of different sensors (e.g., electrocardiogram (ECG) signals from electrodes attached to a patient, etc.), the sensors being connected to the subject or patient 170 undergoing an MRI scan. The sequence pulse generator 133 is coupled to and in communication with a scan room interface system 145 that receives signals from various sensors associated with the state of the resonance assembly 140. The scan room interface system 145 is further coupled to and in communication with a patient positioning system 147 that sends and receives signals to control movement of a patient table to a desired position to perform the MRI scan.

The MRI system controller 130 provides gradient waveforms to the gradient driver system 150, and the gradient driver system includes Gₓ (x direction), G_{y} (y direction), and G_{z} (z direction) amplifiers, etc. Each of the Gₓ, G_{y}, and G_{z} amplifiers excites a corresponding gradient coil in the gradient coil assembly 142, so as to generate a magnetic field gradient used to spatially encode an MR signal during an MRI scan. The gradient coil assembly 142 is disposed within the resonance assembly 140, and the resonance assembly further includes a superconducting magnet having a superconducting coil 144 that, in operation, provides a static uniform longitudinal magnetic field B₀ throughout a cylindrical imaging volume 146. The resonance assembly 140 further includes an RF body coil 148, which, in operation, provides a transverse magnetic field B₁, the transverse magnetic field B₁ being substantially perpendicular to B₀ throughout the entire cylindrical imaging volume 146. The resonance assembly 140 may further include an RF surface coil 149 for imaging different anatomical structures of the patient undergoing the MRI scan. The RF body coil 148 and the RF surface coil 149 may be configured to operate in a transmit and receive mode, a transmit mode, or a receive mode.

The x direction may also be referred to as a frequency encoding direction or a kₓ direction in the k-space, the y direction may be referred to as a phase encoding direction or a k_{y} direction in the k-space, and the z direction may be referred to as a layer surface selection (layer selection) direction. Gₓ can be used for frequency encoding or signal readout, and is generally referred to as a frequency encoding gradient or a readout gradient. G_{y} can be used for phase encoding, and is generally referred to as a phase encoding gradient. G_{z} can be used for slice (layer) position selection to acquire k-space data. It should be noted that a layer selection direction, a phase encoding direction, and a frequency encoding direction may be modified according to actual requirements.

The subject or patient 170 of the MRI scan may be positioned within the cylindrical imaging volume 146 of the resonance assembly 140. The transceiver 135 in the MRI system controller 130 generates RF excitation pulses amplified by an RF amplifier 162, and provides the same to the RF body coil 148 through a transmit/receive switch (also known as T/R switch or switch) 164.

As described above, the RF body coil 148 and the RF surface coil 149 may be used to transmit RF excitation pulses and/or receive resulting MR signals from the patient undergoing the MRI scan. The MR signals emitted by excited nuclei in the patient of the MRI scan may be sensed and received by the RF body coil 148 or the RF surface coil 149 and sent back to a preamplifier 166 through the T/R switch 164. The T/R switch 164 may be controlled by a signal from the sequence pulse generator 133 to electrically connect the RF amplifier 162 to the RF body coil 148 in the transmit mode and to connect the preamplifier 166 to the RF body coil 148 in the receive mode. The T/R switch 164 may further enable the RF surface coil 149 to be used in the transmit mode or the receive mode.

In some embodiments, the MR signals sensed and received by the RF body coil 148 or the RF surface coil 149 and amplified by the preamplifier 166 are stored in the memory 137 for post-processing as a raw k-space data array. A reconstructed magnetic resonance image may be acquired by transforming/processing the stored raw k-space data.

In some embodiments, the MR signals sensed and received by the RF body coil 148 or the RF surface coil 149 and amplified by the preamplifier 166 are demodulated, filtered, and digitized in a receiving portion of the transceiver 135, and transmitted to the memory 137 in the MRI system controller 130. For each image to be reconstructed, the data is rearranged into separate k-space data arrays, and each of said separate k-space data arrays is inputted to the array processor 139, the array processor being operated to transform the data into an array of image data by Fourier transform.

The array processor 139 uses transform methods, most commonly Fourier transform, to create images from the received MR signals. These images are transmitted to the computer system 120 and stored in the memory 126. In response to commands received from the operator workstation 110, the image data may be stored in a long-term memory, or may be further processed by the image processor 128 and transmitted to the operator workstation 110 for presentation on the display 118.

In various embodiments, components of the computer system 120 and the MRI system controller 130 may be implemented on the same computer system or on a plurality of computer systems. It should be understood that the MRI system 100 shown in FIG. 1 is intended for illustration. Suitable MRI systems may include more, fewer, and/or different components.

The MRI system controller 130 and the image processor 128 may separately or collectively include a computer processor and a storage medium. The storage medium records a predetermined data processing program to be executed by the computer processor. For example, the storage medium may store a program used to implement scanning processing (such as a scan flow and an imaging sequence), image reconstruction, medical imaging, etc. For example, the storage medium may store a program used to implement the magnetic resonance imaging method according to the embodiments of the present invention. The described storage medium may include, for example, a ROM, a floppy disk, a hard disk, an optical disk, a magneto-optical disk, a CD-ROM, or a non-volatile memory card.

The MRI system 100 further includes an image capture apparatus 180. The image capture apparatus 180 is configured to acquire information such as visual and morphological information of a scan subject. In general, the image capture apparatus 180 may be mounted near an examination table, thereby enabling image information, e.g., the color image or depth image of the subject, of the scan subject to be maximally collected in a non-contact manner. The image information may be used to assist with medical imaging operations. For example, the image information acquired by the image capture apparatus 180 may be used for keypoint recognition of the subject (that is, landmark recognition), so that a subsequent scanning operation may be performed according to a result of the keypoint recognition.

Description is made below in conjunction with the embodiments.

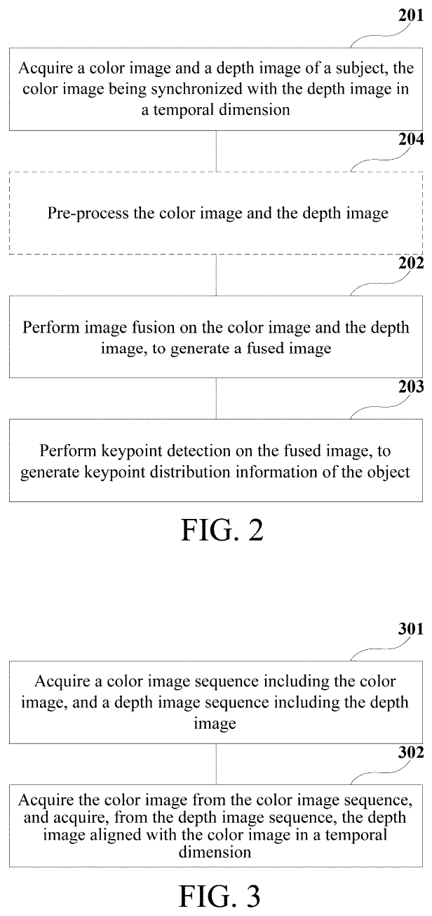

Provided in the embodiments of the present application is a keypoint detection method for medical imaging. FIG. 2 is a schematic diagram of a keypoint detection method for medical imaging according to an embodiment of the present application. As shown in FIG. 2, the method includes a step 201: acquiring a color image and a depth image of a subject, the color image being synchronized with the depth image in a temporal dimension. The method further includes a step 202: performing image fusion on the color image and the depth image, to generate a fused image; and a step 203: performing keypoint detection on the fused image, to generate keypoint distribution information of the subject.

According to the above embodiments, by means of acquiring a color image and a depth image which are synchronized in the temporal dimension, image fusion is performed on the color image and the depth image, to generate a fused image, and keypoint detection is performed on the fused image, to generate keypoint distribution information. Therefore, the accuracy and reliability of the keypoint distribution information can be improved, required computing resources can be reduced, computational efficiency can be improved, detection operation can be simplified, and detection efficiency can be ensured.

Specifically, by means of performing image fusion of the color image and the depth image to generate the fused image before keypoint detection, the fused image can be subjected to keypoint detection using a deep learning model, and it is not necessary to train models for color images and depth images, respectively. Thus, a detection operation can be simplified, and detection efficiency can be improved. In addition, since the color image and the depth image are simultaneously considered at the time of keypoint detection, the accuracy and reliability of the detection result can be improved as compared with the case where only the color image or the depth image is considered at the time of keypoint detection, thereby contributing to improved accuracy and reliability of the keypoint distribution information.

In some embodiments, the color image may be included in a color image sequence, and the depth image may be included in a depth image sequence. In the above method, a fused image sequence may be generated from the color image sequence and the depth image sequence, key point detection may be performed on each fused image in the fused image sequence, and key point distribution information may be generated according to the detection result.

Since image sequence information within a period of time is considered in the process of determining the keypoint distribution information, the accuracy and reliability of the keypoint distribution information can be further improved as compared with the method of determining the keypoint distribution information only according to an image acquired at a single time point.

FIG. 3 is a schematic diagram of the implementation of step 201 according to an embodiment of the present application. As shown in FIG. 3, step 201 may include a step 301: acquiring a color image sequence including the color image and a depth image sequence including the depth image; and a step 302: acquiring the color image from the color image sequence, and acquiring, from the depth image sequence, the depth image aligned with the color image in a temporal dimension.

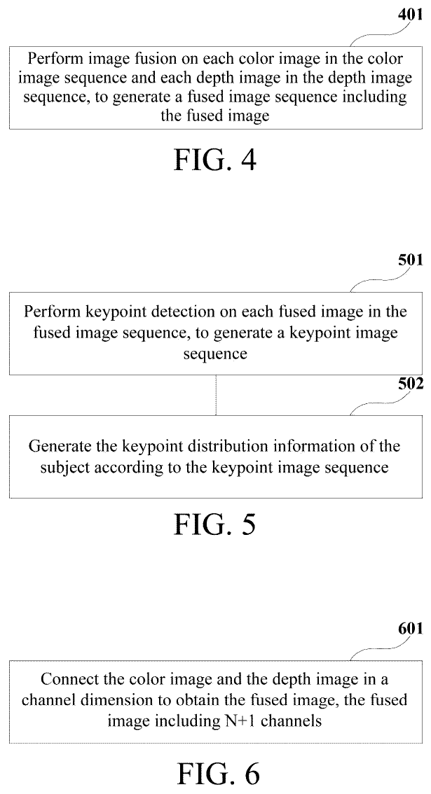

FIG. 4 is a schematic diagram of the implementation of step 202 according to an embodiment of the present application. As shown in FIG. 4, step 202 may include: a step 401: performing image fusion on each color image in the color image sequence and each depth image in the depth image sequence, to generate a fused image sequence including the fused image.

FIG. 5 is a schematic diagram of the implementation of step 203 according to an embodiment of the present application. As shown in FIG. 5, step 203 may include: 1) Step 501: performing keypoint detection on each fused image in the fused image sequence, to generate a keypoint image sequence; and 2) Step 502: generating the keypoint distribution information of the subject according to the keypoint image sequence.

In some embodiments, each color image may include a plurality of pixel points, and the value of each pixel point may include the value of each color component. The color components may include red, green, and blue (RGB) components and the like.

The color image may include N color channels, N being an integer greater than or equal to 1. Each color channel of the color image corresponds to each color component of the color image, respectively. For example, an RGB image may include three color channels, namely, an R channel, a G channel, and a B channel.

The color image may be represented by a matrix of pixel values, and the dimensions of the matrix may be [H1, W1, C1], where H1 represents the height of the color image, W1 represents the width of the color image, and C1 represents the number of channels of the color image. For example, a color image [640, 360, 3] indicates that the color image includes 3 channels, each channel includes 640*360 pixels, and each pixel has a value of a corresponding color component, e.g., a pixel value of an R channel is a value of an R color component. The value of a pixel may be an integer in the interval [0, 255].

In some embodiments, each depth image may include a plurality of pixel points, and the value of each pixel point may include a depth value of the pixel. The depth value of the pixel may be the distance between the pixel and a reference plane or the like. The reference plane is, for example, an image capture plane of the image capture apparatus. The depth image may include one depth channel. Each color channel of the color image corresponds to each color component of the color image, respectively.

The depth image may be represented by a matrix of pixel values, and the dimensions of the matrix may be [H2, W2, C2], where H2 represents the height of the depth image, W2 represents the width of the depth image, and C2 represents the number of channels of the depth image. For example, the depth image [640, 360, 1] indicates that the depth image includes 1 channel, the channel includes 640*360 pixels, and the value of each pixel is a depth value of the pixel.

In some embodiments, in step 202, image fusion may be performed on the color image and the depth image by various means. FIG. 6 is another schematic diagram of the implementation of step 202 according to an embodiment of the present application. As shown in FIG. 6, step 202 may include: a step 601: connecting the color image and the depth image in a channel dimension to obtain the fused image, the fused image including N+1 channels.

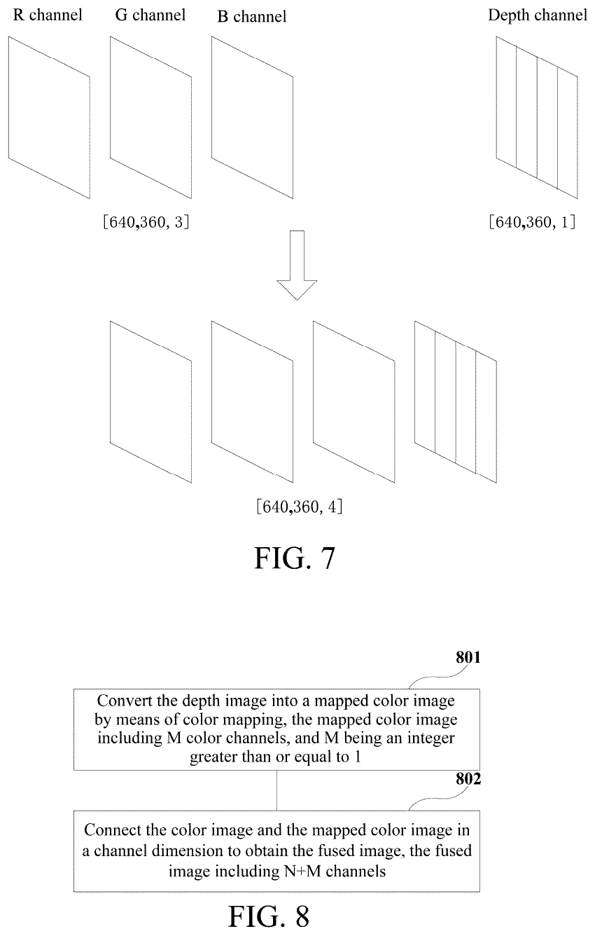

Step 601 is exemplarily described below, using FIG. 7 as an example. FIG. 7 is a schematic diagram of image fusion according to an embodiment of the present invention. As shown in FIG. 7, the color image includes the three color channels R, G, and B, each color channel including 640*360 pixels, and the depth image includes one depth channel, the depth channel including 640*360 pixels.

In step 601, the three color channels R, G, and B may be connected to the depth channel to obtain a fused image, the fused image being a pixel matrix of [640, 360, 4]. For example, as shown in FIG. 7, the depth channel may be connected behind the three color channels R, G, and B. The present application is not limited thereto, and the depth channel may also be connected at other positions, e.g., in front of the three color channels R, G, and B, or between the three color channels R, G, and B.

FIG. 8 is another schematic diagram of the implementation of step 202 according to an embodiment of the present application. As shown in FIG. 8, step 202 may include: 1) step 801: converting the depth image into a mapped color image by means of color mapping, the mapped color image including M color channels, M being an integer greater than or equal to 1; and 2) step 802: connecting the color image and the mapped color image in a channel dimension to obtain the fused image, the fused image including N+M channels.

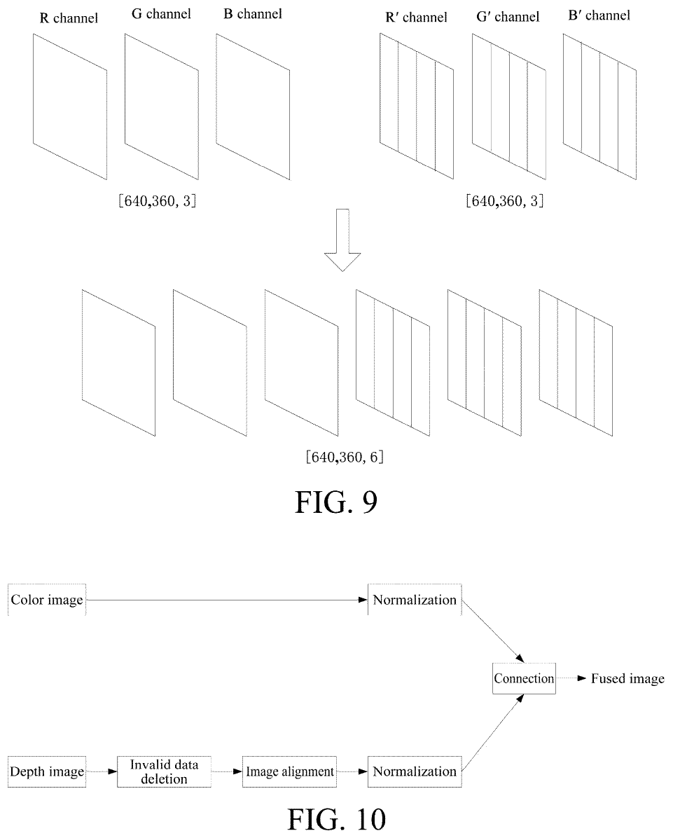

Step 801 and step 802 are exemplarily described below using FIG. 9 as an example. FIG. 9 is another schematic diagram of image fusion according to an embodiment of the present invention. As shown in FIG. 9, the color image includes the three color channels R, G, and B, each color channel including 640*360 pixels, and the depth image includes one depth channel, the depth channel including 640*360 pixels.

In step 801, the depth image may be converted into three color channels, R′, G′, and B′, by means of color mapping. In step 802, the three color channels R, G, and B may be connected to the three color channels R′, G′, and B′ to obtain the fused image, the fused image being a pixel matrix of [640, 360, 6].

For example, as shown in FIG. 9, the three color channels R′, G′, and B′ may be sequentially connected behind the three color channels R, G, and B. The present application is not limited thereto, and the three color channels R′, G′, and B′ may also be connected at other positions, e.g., in front of the three color channels R, G, and B, or between the three color channels R, G, and B.

In addition, when the depth image is converted into the mapped color image, the depth image may also be converted into another number of color channels, for example, one color channel (for example, any one of the three color channels R′, G′, and B′) or two color channels (for example, any two of the three color channels R′, G′, and B′).

In some embodiments, as shown in FIG. 1, the method may further include: Step 204: pre-processing the color image and the depth image.

If step 204 is included, then, in step 202, the pre-processed color image and the pre-processed depth image are fused to generate the fused image.

In some embodiments, the pre-processing of the depth image includes at least one of the following: deleting invalid data in the depth image; aligning the depth image with the color image; or normalizing the depth image.

In some embodiments, the image capture apparatus may include a first image capture portion for acquiring a color image, and a second image capture portion for acquiring a depth image. The first image capture portion and the second image capture portion do not completely overlap in space, so the acquired color image and depth image have different image capture ranges.

When the depth image is pre-processed, a correspondence between each pixel in the color image and each pixel in the depth image may be determined according to parameters of the first image capture portion and the second image capture portion. Pixels included in the depth image and not included in the color image are deleted from the depth image as invalid data. Thus, the influence on the result of keypoint detection can be avoided.

Or, if the depth image acquired by the second image capture portion includes data other than depth information, the other data is deleted from the depth image as invalid data. For example, if the first 60 pixels of the depth image are image frame header information, the first 60 pixels may be deleted or set to 0.

In some embodiments, the depth image and the color image may be aligned when the depth image is pre-processed. For example, a correspondence between each pixel in the color image and each pixel in the depth image is determined according to parameters of the first image capture portion and the second image capture portion, and image alignment is performed according to the correspondence. The correspondence is, for example, an affine transformation.

The present application is not limited thereto, and the depth image and the color image may not be aligned when the depth image is pre-processed. For example, when the deep learning model is trained, a depth image and a color image which are not aligned are inputted, so that a deep learning model capable of processing unaligned images is obtained.

In some embodiments, the depth image may be normalized when the depth image is pre-processed. For example, normalization is performed using a maximum value or an empirical value of pixels in the depth image.

In some embodiments, the pre-processing of the color image may include: normalizing the color image. For example, normalization is performed using a maximum value or an empirical value of pixels in the color image. When the value range of the pixel in the color image is [0, 255], the empirical value may be 255.

The flow of step 202 is exemplarily described below with reference to FIG. 10. FIG. 10 is a schematic diagram of the flow of steps 202 and 204 according to an embodiment of the present application. As shown in FIG. 10, in step 204, the color image may be normalized to obtain a pre-processed color image, and the depth image subjected to invalid data deletion, image alignment, and normalization to obtain a pre-processed depth image. In step 204, the channels of the pre-processed color image and the pre-processed depth image are connected, to obtain the fused image.

In a case involving conversion of the depth image into a mapped color image by means of color mapping, the color mapping operation may be performed after invalid data deletion. The present application is not limited thereto, and the color mapping operation may also be performed in other orders.

In some embodiments, in step 203, keypoint detection is performed on the fused image using a keypoint detection model (deep learning model) to generate keypoint distribution information of the subject. The keypoints may be, for example, feature points related to body parts and capable of being detected in an image. The keypoint distribution information may include the types of the keypoints or the positions of the keypoints, etc.

The types of the keypoints may include at least one of the following: head, chest, abdomen, neck, nose, left shoulder, right shoulder, left hip, right hip, left eye, right eye, left elbow, right elbow, left knee, right knee, left ear, right ear, left wrist, right wrist, left ankle, and right ankle. The present application is not limited thereto, and the type of the key point may also include other contents.

Position information of the keypoints may be represented by pixel positions in the image. The present application is not limited thereto, and the position information of the key point may be represented in other manners.

The input of the keypoint detection model is a fused image, and the output of the keypoint detection model is a keypoint image which includes keypoint information. The keypoint information may include the type of at least one keypoint or the position of the at least one keypoint, etc. For the specific manner of performing keypoint detection using the keypoint detection model, reference may be made to the related art, which will not be extensively described here.

When the number of fused images is 1, the keypoint information of the keypoint image outputted by the keypoint detection model is the keypoint distribution information.

When the number of fused images is more than 1, the keypoint distribution information may be generated based on the keypoint information of the plurality of keypoint images. That is, as described above, keypoint detection is performed on each fused image in the fused image sequence using the keypoint detection model, to generate a keypoint image sequence (step 501); and the keypoint distribution information of the subject is generated according to the keypoint image sequence (step 502).

In some embodiments, the keypoint distribution information may be generated according to the keypoint image sequence by various means.

For example, when there is an obscured key point in a current keypoint image (for ease of description, an obscured keypoint in the current keypoint image is referred to as a first keypoint), a next keypoint image in the keypoint image sequence is determined: in that keypoint image, keypoints of the same type as the first keypoint are not obscured (for ease of description, unobscured keypoints of the same type as the first keypoint in the determined keypoint image are referred to as second keypoints). The keypoint distribution information is generated according to the current keypoint image and the determined keypoint image.

For a first keypoint that is obscured in the current keypoint image, a keypoint image including the unobscured second key point is determined in the keypoint image sequence. Therefore, when the keypoint distribution information is jointly generated according to the current keypoint image and the determined keypoint image, more available information related to the first keypoint can be obtained, so that the accuracy and reliability of the keypoint distribution information can be improved.

In some embodiments, the keypoint image may be the last keypoint image in the keypoint image sequence. Since the last keypoint image is the keypoint image closest to the current time, keypoint distribution information determined based on the last keypoint image can reflect current position information of a subject more accurately. The present application is not limited thereto, and the current keypoint image may also be any one or more keypoint images in the keypoint image sequence.

In some embodiments, it may be determined whether an obscured first keypoint is present in the current keypoint image. For example, the obscured first keypoint has a lower degree of confidence, etc.

In some embodiments, the determined keypoint image may be the next keypoint image: the determined keypoint image includes a second keypoint and is closest to the current keypoint image in the temporal dimension. As an interval time gets shorter, the subject is less likely to be displaced in the interval time, and therefore, determining keypoint distribution information according to the determined keypoint image and the current keypoint image can further improve the reliability and accuracy of the keypoint distribution information.

In some embodiments, the keypoint distribution information may be determined according to the determined keypoint image and the current keypoint image by various means.

For example, position information of the second keypoint in the determined keypoint image is directly used as position information of the first keypoint in the current keypoint image.

Alternatively, position information of the second keypoint in the determined keypoint image and the position information of the first keypoint in the current keypoint image are weighted or averaged, and the result of the weighting or averaging is used as the final position information of the first keypoint. The weighting coefficient may be the degree of confidence of the first keypoint and the second keypoint, etc.

In some embodiments, the keypoint distribution information may be further processed, for example, keypoint grouping, pose estimation, etc., are performed according to the keypoint distribution information. Thus, more effective information can be provided for a subsequent scanning operation.

In some embodiments, the keypoint detection model may be a deep learning model trained according to a preset training data set.

In some embodiments, the training data set may include a plurality of pieces of training data, each piece of training data including an input image and keypoint distribution information.

For example, in the training process, the deep learning model performs layer-by-layer calculation according to an input image, to obtain a detection result; a loss function is calculated according to the detection result and the keypoint distribution information; and an error is calculated according to the loss function, and the parameters of the deep learning model are updated by means of a back propagation algorithm. The above steps are cyclically iterated until the loss function converges or a preset stop condition is reached.

In some embodiments, each input image of the training data set may be generated by the following means: 1) acquiring a first color image and a first depth image of a subject, the first color image being synchronized with the first depth image in a temporal dimension; and 2) performing image fusion on the first color image and the first depth image, and using the generated first fused image as the input image.

For the method for acquiring the first color image and the first depth image, reference may be made to the foregoing step 201; and for the method for performing image fusion on the first color image and the first depth image, reference may be made to the foregoing step 202, which will not be described again here.

In some embodiments, before image fusion is performed on the first color image and the first depth image, first pre-processing may also be performed.

The first pre-processing of the first depth image includes at least one of the following: deleting invalid data in the first depth image; aligning the first depth image with the first color image; normalizing the first depth image; or performing random erasing.

The specific means of deleting invalid data in the first depth image, aligning the first depth image with the first color image, and normalizing the first depth image are similar to the specific means of deleting invalid data in the first depth image, aligning the depth image with the color image, and normalizing the depth image, and will not be described again here.

The random erasing may be a process of correcting a pixel value of the first depth image according to a random number in a partial region in the first depth image. Thus, it is possible to simulate a scenario in which the subject is obscured by a covering (for example, a coil, a blanket, complex clothes, or a mask) (for example, in an MRI scenario, it is necessary to cover the surface of the subject with the coil). Thus, more input images can be generated, contributing to improving the robustness of the keypoint detection model.

The first pre-processing of the first color image includes at least one of the following: normalizing the first color image; performing brightness processing on the first color image; or performing random erasing.

The specific means of normalizing the first color image and performing random erasing are similar to the specific means of normalizing the color image and performing random erasing on the depth image as described above, and will not be described again here.

Performing brightness processing on the first color image may be a process of adjusting the brightness of the first color image, so that input images having various brightnesses can be generated. Thus, the input image can be enriched, contributing to improving the robustness of the keypoint detection model.

In some embodiments, after image fusion is performed on the first color image and the first depth image, second pre-processing may further be performed on the first fused image. The second pre-processing may be processing related to a position transformation, for example, the second pre-processing may include at least one of the following: image flipping, image rotation, image shifting, image scaling, and image cropping. Therefore, input images having various angles and ranges can be generated according to the first fused image, contributing to improving the robustness of the keypoint detection model.

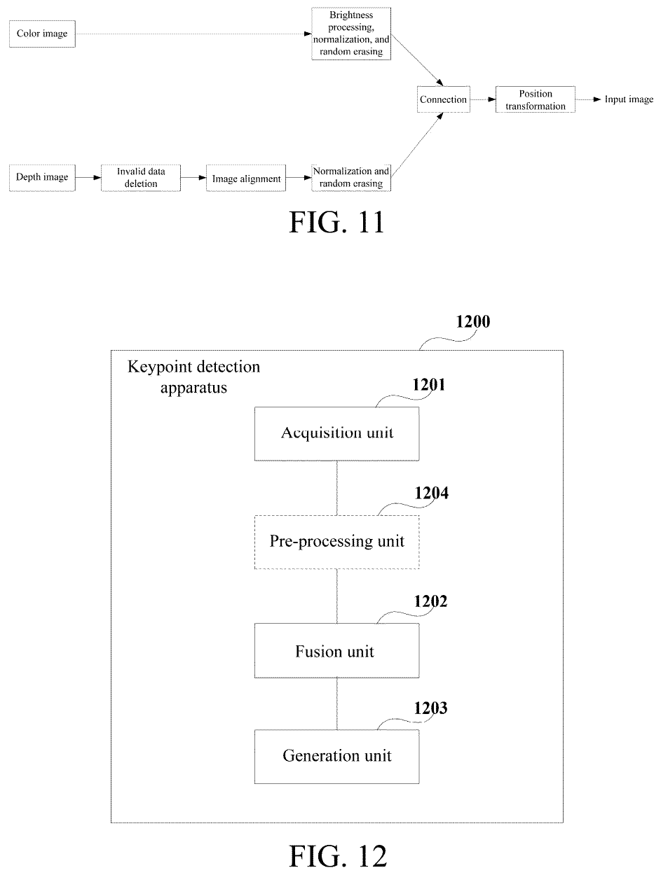

The flow of generating the input image is described below with reference to FIG. 11. FIG. 11 is a schematic diagram of a flow of generating an input image according to an embodiment of the present application. As shown in FIG. 11, when an input image is generated, brightness processing, normalization, random erasing, and the like may be performed on a color image to obtain a first pre-processed color image. Invalid data deletion, image alignment, normalization, and random erasing are performed on the depth image to obtain a first pre-processed depth image. Channels of the first pre-processed color image and the first pre-processed depth image are connected, to obtain the first fused image. The first fused image is subjected to position transformation, for example, image flipping, image rotation, image shifting, image scaling, and image cropping, thereby obtaining the input image. In a case involving the conversion of the first depth image into a mapped first color image by means of color mapping, the color mapping operation may be performed after the invalid data deletion. The present application is not limited thereto, and the color mapping operation may also be performed in other orders.

In some embodiments, in steps 202 and 203, image fusion may be performed on the color image and the depth image by means of a deep learning model, to generate the fused image, and keypoint detection may be performed on the fused image, to generate the keypoint distribution information. Performing image fusion and keypoint detection by means a deep learning model can further simplify a detection operation and improve detection efficiency.

In some embodiments, the deep learning model is trained according to a preset training data set, the training data set may include a plurality of pieces of training data, and each piece of training data includes an input image and keypoint distribution information. The input image includes a first color image and a first depth image of the subject.

It should be noted that the above figures merely schematically illustrate the embodiments of the present application, but the present application is not limited thereto. For example, the order of execution between operations may be appropriately adjusted. In addition, some other operations may be added, or some operations may be omitted (for example, operations or steps corresponding to dashed boxes in the figures). Those skilled in the art can make appropriate variations according to the above content, rather than being limited by the disclosure of the foregoing accompanying drawings.

The above embodiments merely provide illustrative descriptions of the embodiments of the present application. However, the present application is not limited thereto, and appropriate variations may be made on the basis of the above embodiments. For example, each of the above embodiments may be used independently, or one or more among the above embodiments may be combined.

According to the above embodiments, by means of acquiring a color image and a depth image which are synchronized in the temporal dimension, image fusion is performed on the color image and the depth image, to generate a fused image, and keypoint detection is performed on the fused image, to generate keypoint distribution information. Therefore, the accuracy and reliability of the keypoint distribution information can be improved, required computing resources can be reduced, computational efficiency can be improved, a detection operation can be simplified, and detection efficiency can be ensured.

Further provided in the embodiments of the present application is a keypoint detection apparatus for medical imaging, of which the same content as that of the above-mentioned embodiments will not be repeated.

FIG. 12 is a schematic diagram of a keypoint detection apparatus for medical imaging according to an embodiment of the present application. As shown in FIG. 12, the keypoint detection apparatus 1200 for medical imaging includes: an acquisition unit 1201, acquiring a color image and a depth image of a subject, the color image being synchronized with the depth image in a temporal dimension. The keypoint detection apparatus 1200 further includes a fusion unit 1202, performing image fusion on the color image and the depth image to generate a fused image; and a generation unit 1203, performing keypoint detection on the fused image to generate keypoint distribution information of the subject.

In some embodiments, the color image includes N color channels, N being an integer greater than or equal to 1, the depth image includes one depth channel, the fusion unit connects the color image and the depth image in a channel dimension to obtain a fused image, and the fused image includes N+1 channels.

In some embodiments, the color image includes N color channels, N being an integer greater than or equal to 1, the depth image includes one depth channel, the fusion unit converts the depth image into a mapped color image by means of color mapping, and the mapped color image includes M color channels, M being an integer greater than or equal to 1; and the color image and the mapped color image are connected in a channel dimension to generate the fused image, the fused image including N+M channels.

In some embodiments, as shown in FIG. 12, the keypoint detection apparatus 1200 for medical imaging further includes: a pre-processing unit 1204, pre-processing the color image and the depth image; and a fusion unit 1202, fusing the pre-processed color image and the pre-processed depth image to generate the fused image.

In some embodiments, the pre-processing of the depth image includes at least one of the following: deleting invalid data in the depth image; aligning the depth image with the color image; or normalizing the depth image.

In some embodiments, the pre-processing of the color image includes: normalizing the color image.

In some embodiments, the generation unit 1203 generates the keypoint distribution information by performing keypoint detection on the fused image by means of a deep learning model (keypoint detection model).

In some embodiments, the deep learning model (keypoint detection model) is a deep learning model trained according to a preset training data set.

In some embodiments, the training data set includes a plurality of pieces of training data, each piece of training data including an input image and keypoint distribution information, and the input image being generated by the following means:
Acquiring a first color image and a first depth image of a subject, the first color image being synchronized with the first depth image in a temporal dimension; and
Performing image fusion on the first color image and the first depth image, and using a generated first fused image as the input image.

In some embodiments, first pre-processing is further performed before image fusion is performed on the first color image and the first depth image.

The first pre-processing of the first depth image includes at least one of the following: deleting invalid data in the first depth image; aligning the first depth image with the first color image; normalizing the first depth image; or performing random erasing.

The first pre-processing of the first color image includes at least one of the following: normalizing the first color image; performing brightness processing on the first color image; or performing random erasing.

In some embodiments, second pre-processing is performed on the first fused image after image fusion is performed the first color image and the first depth image. The second pre-processing includes at least one of the following: image flipping, image rotation, image shifting, image scaling, and image cropping.

In some embodiments, the fusion unit 1202 and the generation unit 1203 may perform image fusion on the color image and the depth image by means of a deep learning model to generate the fused image, perform keypoint detection on the fused image, and generate the keypoint distribution information.

In some embodiments, the deep learning model is trained according to a preset training data set, the training data set includes a plurality of pieces of training data, each piece of training data includes an input image and keypoint distribution information, and the input image includes the first color image and the first depth image.

In some embodiments, the acquisition unit 1201 acquires a color image sequence including the color image, and a depth image sequence including the depth image, acquires the color image from the color image sequence, and acquires, from the depth image sequence, the depth image aligned with the color image in a temporal dimension.

In some embodiments, the fusion unit 1202 performs image fusion on each color image in the color image sequence and each depth image in the depth image sequence, to generate a fused image sequence including the fused image.

In some embodiments, the generation unit 1203 performs keypoint detection on each fused image in the fused image sequence, to generate a keypoint information sequence, and generates the keypoint distribution information of the subject according to the keypoint information sequence.

It is worth noting that only the components or modules related to the present application have been described above, but the present application is not limited thereto. The keypoint detection apparatus for medical imaging may further include other components or modules, or omit some components or modules (for example, components or modules corresponding to dashed boxes in the figures). For the specific contents of these components or modules, reference may be made to the related art.

In addition, for simplicity, the above figures only exemplarily illustrate connection relationships or signal directions between various components or modules, but it should be clear to those skilled in the art that various related technologies such as bus connection may be used. The various components or modules may be implemented by means of hardware facilities such as a processor, a memory, a transmitter, and a receiver. The implementation of the present application is not limited thereto.

According to the above embodiments, by means of acquiring a color image and a depth image which are synchronized in the temporal dimension, image fusion is performed on the color image and the depth image, to generate a fused image, and keypoint detection is performed on the fused image, to generate keypoint distribution information. Therefore, the accuracy and reliability of the keypoint distribution information can be improved, required computing resources can be reduced, computational efficiency can be improved, detection operation can be simplified, and detection efficiency can be ensured.

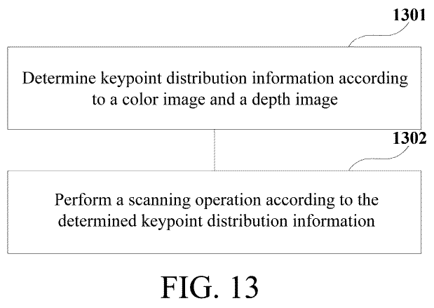

Embodiments of the present application further provide a medical imaging method. FIG. 13 is a schematic diagram of a medical imaging method according to an embodiment of the present application. As shown in FIG. 13, the medical imaging method includes: 1) step 1301: determining keypoint distribution information according to a color image and a depth image; and 2) step 1302: performing a scanning operation according to the determined keypoint distribution information.

In step 1301, the keypoint distribution information may be determined according to the keypoint detection method for medical imaging described in the aforementioned embodiments. The contents thereof are incorporated herein and will not be further described.

In some embodiments, in step 1302, performing the scanning operation according to the determined keypoint distribution information may include: positioning the scan subject according to the keypoint distribution information.

In some embodiments, step 1302 may further include: performing a scanning operation on the positioned scan subject.

It should be noted that the above figures merely schematically illustrate the embodiments of the present application, but the present application is not limited thereto. For example, the order of execution between operations may be appropriately adjusted. In addition, some other operations may be added, or some operations may be omitted (for example, operations or steps corresponding to dashed boxes in the figures). Those skilled in the art can make appropriate variations according to the above content, rather than being limited by the disclosure of the foregoing accompanying drawings.

The above embodiments merely provide illustrative descriptions of the embodiments of the present application. However, the present application is not limited thereto, and appropriate variations may be made on the basis of the above embodiments. For example, each of the above embodiments may be used independently, or one or more among the above embodiments may be combined.

According to the above embodiments, by means of acquiring a color image and a depth image which are synchronized in the temporal dimension, image fusion is performed on the color image and the depth image, to generate a fused image, and keypoint detection is performed on the fused image, to generate keypoint distribution information. Therefore, the accuracy and reliability of the keypoint distribution information can be improved, required computing resources can be reduced, computational efficiency can be improved, detection operation can be simplified, and detection efficiency can be ensured.

Embodiments of the present application further provide a medical imaging system. The configuration of the medical imaging system is as shown in FIG. 1, and repeated portions will not be described again.

In some embodiments, unlike the medical imaging system in FIG. 1, the controller 130 is configured to perform the keypoint detection method for medical imaging described previously, for example, acquiring a color image and a depth image of a subject, the color image being synchronized with the depth image in a temporal dimension; performing image fusion on the color image and the depth image, to generate a fused image; and performing keypoint detection on the fused image, to generate keypoint distribution information of the subject.

In some embodiments, the controller 130 (which may also be a processor) includes a computer processor and a storage medium. The storage medium records a predetermined data processing program to be executed by the computer processor. For example, the storage medium may store a program configured to implement scanning processing (for example, including waveform design/conversion), image reconstruction, medical imaging, and the like. For example, the storage medium may store a program configured to implement the keypoint detection method for medical imaging according to the embodiments of the present invention. The keypoint detection method for medical imaging includes: acquiring a color image and a depth image of a subject, the color image being synchronized with the depth image in a temporal dimension; performing image fusion on the color image and the depth image, to generate a fused image; and performing keypoint detection on the fused image, to generate keypoint distribution information of the subject. The specific implementations are as described above, and will not be described again here. The described storage medium may include, for example, a ROM, a floppy disk, a hard disk, an optical disk, a magneto-optical disk, a CD-ROM, or a non-volatile memory card.

The present application is not limited thereto, and the keypoint detection method for medical imaging may also be performed in other processors in the MRI system 100, or by a cloud processor.

In some embodiments, a scanning assembly may perform a scanning operation according to the keypoint distribution information determined by the controller 130. The scanning assembly may include a positioning assembly that may position the scan subject according to the keypoint distribution information. For example, according to the keypoint distribution information, a region of interest to be imaged is determined, and a relative position between the subject and the center of a scanning device is adjusted to align a coordinate center of the determined region of interest with a scanning center of an imaging device. The positioning assembly is, for example, the patient positioning system 147 of the MRI system 100.

In some embodiments, the scanning assembly may further include the scanning unit 111. The scanning unit 111 performs a scanning operation on the positioned scan subject.

According to the above embodiments, by means of acquiring a color image and a depth image which are synchronized in the temporal dimension, image fusion is performed on the color image and the depth image, to generate a fused image, and keypoint detection is performed on the fused image, to generate keypoint distribution information. Therefore, the accuracy and reliability of the keypoint distribution information can be improved, required computing resources can be reduced, computational efficiency can be improved, detection operation can be simplified, and detection efficiency can be ensured.

Further provided in the embodiments of the present application is a computer-readable program. The computer-readable program, when executed in a medical imaging system, causes a computer to execute, in the medical imaging system, the keypoint detection method for medical imaging described in the aforementioned embodiments.

Further provided in the embodiments of the present application is a storage medium having a computer-readable program stored therein. The computer-readable program causes a computer to perform, in a medical imaging system, the medical imaging method described in the aforementioned embodiments.

The above apparatus and method of the present application can be implemented by hardware, or can be implemented by hardware in combination with software. The present application relates to such a computer-readable program that when executed by a logic component, the program causes the logic component to implement the foregoing apparatus or a constituent component, or causes the logic component to implement various methods or steps as described above. The present application further relates to a storage medium for storing the above program, such as a hard disk, a disk, an optical disk, a DVD, a flash memory, etc.

The method/apparatus described in view of the embodiments of the present application may be directly embodied as hardware, a software module executed by a processor, or a combination of the two. For example, one or more of the functional block diagrams and/or one or more combinations of the functional block diagrams shown in the drawings may correspond to either respective software modules or respective hardware modules of a computer program flow. The foregoing software modules may respectively correspond to the steps shown in the figures. The foregoing hardware modules can be implemented, for example, by firming the software modules using a field-programmable gate array (FPGA).

The software modules may be located in a RAM, a flash memory, a ROM, an EPROM, an EEPROM, a register, a hard disk, a portable storage disk, a CD-ROM, or any other form of storage medium known in the art. The storage medium may be coupled to a processor, so that the processor can read information from the storage medium and can write information into the storage medium. Alternatively, the storage medium may be a constituent component of the processor. The processor and the storage medium may be located in an ASIC. The software module may be stored in a memory of a mobile terminal, and may also be stored in a memory card that can be inserted into a mobile terminal. For example, if a device (such as a mobile terminal) uses a large-capacity MEGA-SIM card or a large-capacity flash memory device, the software modules can be stored in the MEGA-SIM card or the large-capacity flash memory apparatus.

One or more of the functional blocks and/or one or more combinations of the functional blocks shown in the accompanying drawings may be implemented as a general-purpose processor, a digital signal processor (DSP), an application-specific integrated circuit (ASIC), a field-programmable gate array (FPGA) or other programmable logic devices, discrete gate or transistor logic devices, a discrete hardware assembly, or any appropriate combination thereof for implementing the functions described in the present application. The one or more functional blocks and/or the one or more combinations of the functional blocks shown in the accompanying drawings may also be implemented as a combination of computing devices, such as a combination of a DSP and a microprocessor, multiple microprocessors, one or more microprocessors in communication combination with a DSP, or any other such configuration.

The present application is described above with reference to specific embodiments. However, it should be clear to those skilled in the art that the foregoing description is merely illustrative and is not intended to limit the scope of protection of the present application. Various variations and modifications may be made by those skilled in the art according to the principle of the present application, and said variations and modifications also fall within the scope of the present application.

1. A keypoint detection method for medical imaging, characterized by comprising:
acquiring a color image and a depth image of a subject, the color image being synchronized with the depth image in a temporal dimension;
performing image fusion on the color image and the depth image, to generate a fused image; and
performing keypoint detection on the fused image to generate keypoint distribution information of the subject.

2. The method according to claim 1, wherein
the color image comprises N color channels, N being an integer greater than or equal to 1, and the depth image comprises one depth channel; and
fusing the color image and the depth image to generate a fused image comprises:
connecting the color image and the depth image in a channel dimension to obtain the fused image, the fused image comprising N+1 channels.

3. The method according to claim 1, wherein
the color image comprises N color channels, N being an integer greater than or equal to 1, and the depth image comprises one depth channel; and
fusing the color image and the depth image to generate a fused image comprises:
converting the depth image into a mapped color image by means of color mapping, the mapped color image comprising M color channels, and M being an integer greater than or equal to 1; and
connecting the color image and the mapped color image in a channel dimension to obtain the fused image, the fused image comprising N+M channels.

4. The method according to claim 1, further comprising:
pre-processing the color image and the depth image; and
fusing the pre-processed color image and the pre-processed depth image, to generate the fused image.

5. The method according to claim 4, wherein the pre-processing of the depth image comprises at least one of the following:
deleting invalid data in the depth image;
aligning the depth image with the color image; or
normalizing the depth image.

6. The method according to claim 4, wherein the pre-processing of the color image comprises normalizing the color image.

7. The method according to claim 1, wherein
keypoint detection is performed on the fused image by means of a deep learning model, to generate the keypoint distribution information.

8. The method according to claim 7, wherein
the deep learning model is trained according to a preset training data set, the training data set comprises a plurality of pieces of training data, each piece of training data comprises an input image and keypoint distribution information, and the input image is generated by the following means:
acquiring a first color image and a first depth image of a subject, the first color image being synchronized with the first depth image in a temporal dimension; and
performing image fusion on the first color image and the first depth image to generate a first fused image, and using the first fused image as the input image.

9. The method according to claim 8, wherein
before performing image fusion on the first color image and the first depth image, first pre-processing is also performed,
wherein the first pre-processing of the first depth image comprises at least one of the following:
deleting invalid data in the first depth image;
aligning the first depth image with the first color image;
normalizing the first depth image; or
performing random erasing; and
the first pre-processing of the first color image comprises at least one of the following:
normalizing the first color image;
performing brightness processing on the first color image; or
performing random erasing.

10. The method according to claim 8, wherein
after performing image fusion on the first color image and the first depth image, second pre-processing is also performed on the first fused image, the second pre-processing comprising at least one of the following:
image flipping, image rotation, image shifting, image scaling, and image cropping.

11. The method according to claim 1, wherein
image fusion is performed on the color image and the depth image by means of a deep learning model, to generate a fused image, and keypoint detection is performed on the fused image, to generate the keypoint distribution information.

12. The method according to claim 11, wherein
the deep learning model is trained according to a preset training data set, the training data set comprises a plurality of pieces of training data, each piece of training data comprises an input image and keypoint distribution information, and the input image comprises a first color image and a first depth image of a subject.

13. The method according to claim 1, wherein acquiring a color image and a depth image of a subject comprises:
acquiring a color image sequence comprising the color image, and a depth image sequence comprising the depth image; and
acquiring the color image from the color image sequence, and acquiring, from the depth image sequence, the depth image aligned with the color image in a temporal dimension.

14. The method according to claim 13, wherein performing image fusion on the color image and the depth image to generate a fused image comprises:
performing image fusion on each color image in the color image sequence and each depth image in the depth image sequence, to generate a fused image sequence comprising the fused image.

15. The method according to claim 14, wherein performing keypoint detection on the fused image to generate keypoint distribution information of the subject comprises:
performing keypoint detection on each fused image in the fused image sequence, to generate a keypoint image sequence; and
generating the keypoint distribution information of the subject according to the keypoint image sequence.

16. A medical imaging method, comprising:
determining keypoint distribution information according to the method of claim 1; and
performing a scanning operation according to the determined keypoint distribution information.

17. The method according to claim 16, wherein performing a scanning operation according to the determined keypoint distribution information comprises:
positioning the subject according to the keypoint distribution information.

18. A medical imaging system, characterized in that the system comprises:
a controller, configured to execute the keypoint detection method for medical imaging of claim 1; and
a scanning assembly, performing a scanning operation according to keypoint distribution information determined by the controller.

19. The medical imaging system according to claim 18, wherein the scanning assembly comprises:
a positioning assembly, positioning the subject according to the keypoint distribution information.
